(19) United States
(12) Patent Application Publication
(10) Pub. No.: US 2014/0164538 A1
(43) Pub. Date: Jun. 12, 2014

(54) ELECTRONIC DEVICE AND METHOD OF RECORDING AND OUTPUTTING MESSAGES

(71) Applicant: HON HAI PRECISION INDUSTRY CO., LTD., New Taipei (TW)

(72) Inventors: YU-CHIEN LIN, New Taipei (TW); SHAN-CHUAN JENG, New Taipei (TW); CHIEN-FA YEH, New Taipei (TW); CHUNG-I LEE, New Taipei (TW)

(73) Assignee: HON HAI PRECISION INDUSTRY CO., LTD., New Taipei (TW)

(21) Appl. No.: 14/076,294

(22) Filed: Nov. 11, 2013

(30) Foreign Application Priority Data
Dec. 11, 2012 (TW) 101146503

(51) Int. Cl. H04L 12/58

(52) U.S. Cl. CPC H04L 51/36
USPC 709/206

(57) ABSTRACT

In a method of recording and outputting messages using an electronic device, a message is recorded using an input device and is stored into a storage device of the electronic device. When a person appears within a detection range of a detection device of the electronic device, the detection device identifies the person, and the message corresponding to the identified person is outputted using an output device of the electronic device.

### BACKGROUND

1. Technical Field

Embodiments of the present disclosure relate to a messaging system, and more specifically relates to a messaging system and method of recording and outputting messages.

2. Description of Related Art

Nowadays, most people are busy with their work and other activities that even family members hardly see each other. In an emergency it is important to contact family members and if family members cannot be reached, it may cause delays in handling important matters. However, many convenient ways of communication are provided, such as leaving a voicemail, an e-mail, an instant message, or a physical note, for people to contact their families.

But, when a first individual leaves a message, such as, a voicemail, an e-mail, an instant message, or a physical note to a second individual, the second individual may not necessarily become aware of the message timely.

In addition, when such a message is destined for one person in the family members, such as a sister, however, it may be received by another person in the family members, such as the father.

### BRIEF DESCRIPTION OF THE DRAWINGS

FIG. 1 is a block diagram of one embodiment of an electronic device for recording and outputting messages.

FIG. 2 is a block diagrams of one embodiment of function modules of a message record and output system in FIG. 1.

FIG. 3 illustrates a flowchart of one embodiment of a method of recording messages.

FIG. 4 illustrates a flowchart of one embodiment of a method of outputting messages.

FIG. 5 illustrates a flowchart of another embodiment of a method of outputting messages.

FIG. 6 is a schematic diagram illustrating a storage device.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

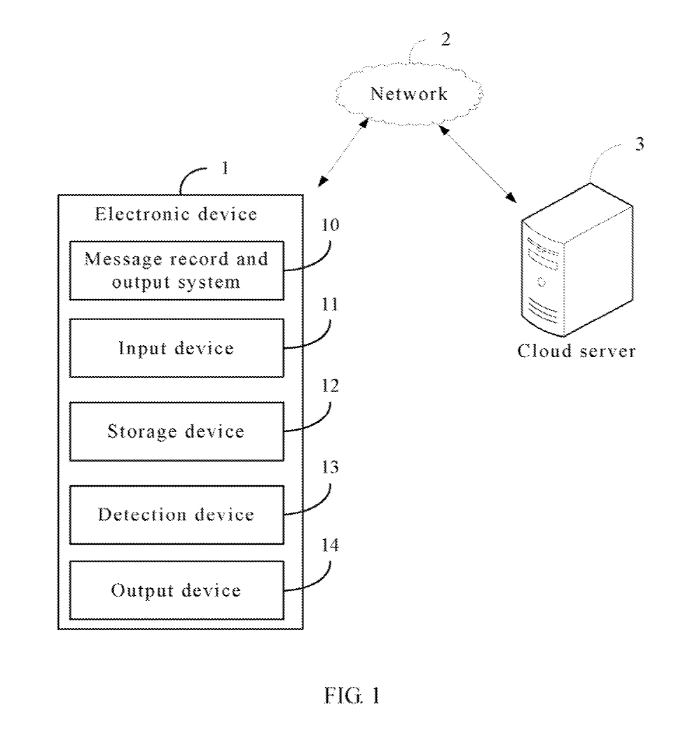

FIG. 1 is a block diagram of one embodiment of an electronic device 1 for recording and outputting messages. The electronic device 1 may be a computer, a smart phone, a smart television, for example. The electronic device 1 includes a message record and output system 10, an input device 11, a storage device 12, a detection device 13, and an output device 14.

The input device 11 may be a microphone, a sound recording pen, a touch screen, a keyword, a video camera, for example.

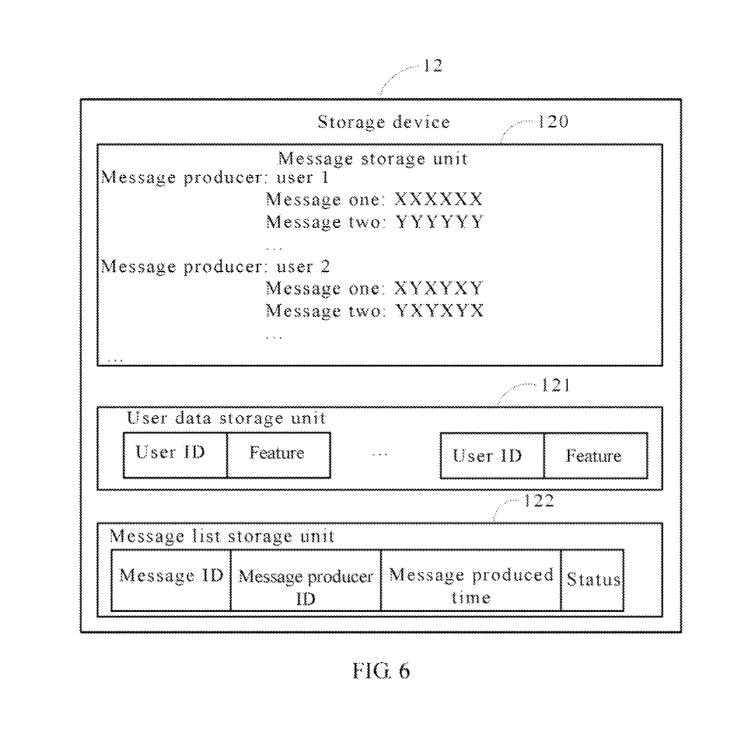

The storage device 12 may include some type(s) of non-transitory computer-readable storage medium, such as a hard disk drive, a compact disc, a digital video disc, or a tape drive. Referring to FIG. 6, the storage device 12 includes a plurality of storage units, such as a message storage unit 120, a user data storage unit 121, and a message list storage unit 122. The message storage unit 120 stores messages produced by all users. The user data storage unit 121 stores features of by all the users, such as faces, voices, and fingerprints. The message list storage unit 122 stores one or more message lists which are used to record a message ID, a message producer ID, a message produced time, and a status of each of the messages, where the status includes read and unread.

The detection device 13 may be a face detection device, a sound detection device, a fingerprint detection device, or other device which can identify an identification of a user. The output device 14 can be a loudspeaker, a display screen, for example.

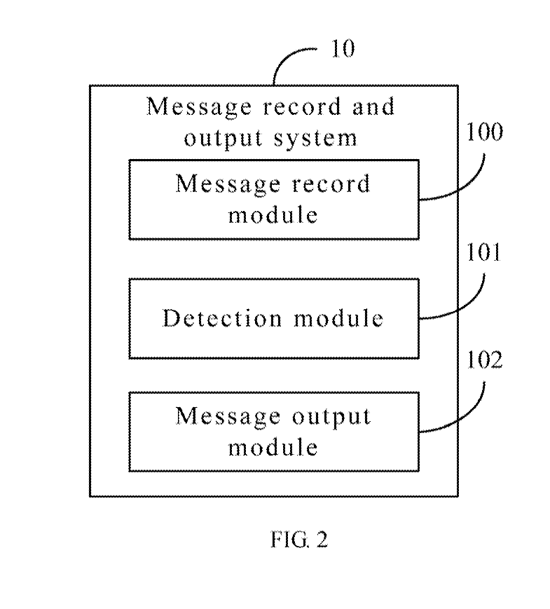

The message record and output system 10 includes a number of function modules (depicted in FIG. 2). The function modules may include computerized codes in the form of one or more programs, which have functions of recording messages using the input device 11, identifying destined message receivers of the messages using the detection device 13, and outputting the messages to the destined message receivers using the output device 14.

In one embodiment, the electronic device 1 connects with a cloud server 3 via a network 2, for cloud storage of the messages.

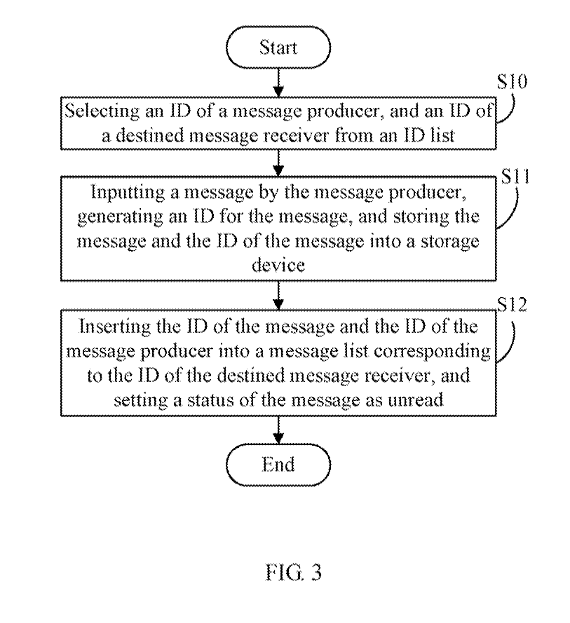

FIG. 2 is a block diagrams of one embodiment of function modules of the message record and output system 10 in FIG. 1. The message record and output system 10 includes a message record module 100, a detection module 101, and a message output module 102. The function modules 100 to 102 provide at least the functions needed to execute the steps illustrated in FIGS. 3 to 5 below.

FIG. 3 illustrates a flowchart of one embodiment of a method of recording message. The method is executed by at least one processor of the electronic device 1. Depending on the embodiment, additional steps in FIG. 3 may be added, others removed, and the ordering of the steps may be changed.

In step S10, a message producer selects an identification (ID) of the message producer and an ID of a destined message receiver from an ID list stored in the storage device 12 or the cloud server 3 using the message record module 100. In one embodiment, the message record module 100 can display the ID list on a display screen of the electronic device 1 to select the ID of the message producer and the ID of the destined message receiver. In one embodiment, the message producer can select IDs of more than one destined message receiver. In one embodiment, the ID of the destined message receiver can be void, which means the destined message receiver can be everyone. The ID list can be edit to add, delete, or change IDs.

In step S11, the message producer inputs a message using the input device 11, and the message record module 100 generates an ID for the message, and stores the message and the ID of the message into the storage device 12 or the cloud server 3. The message can be characters, audio, and/or video.

In step S12, the message record module 100 inserts the ID of the message and the ID of the message producer into a message list corresponding to the ID of the destined message receiver, and sets a status of the message as unread. It may be understood that, the ID of the message are associated to the ID of the message producer.

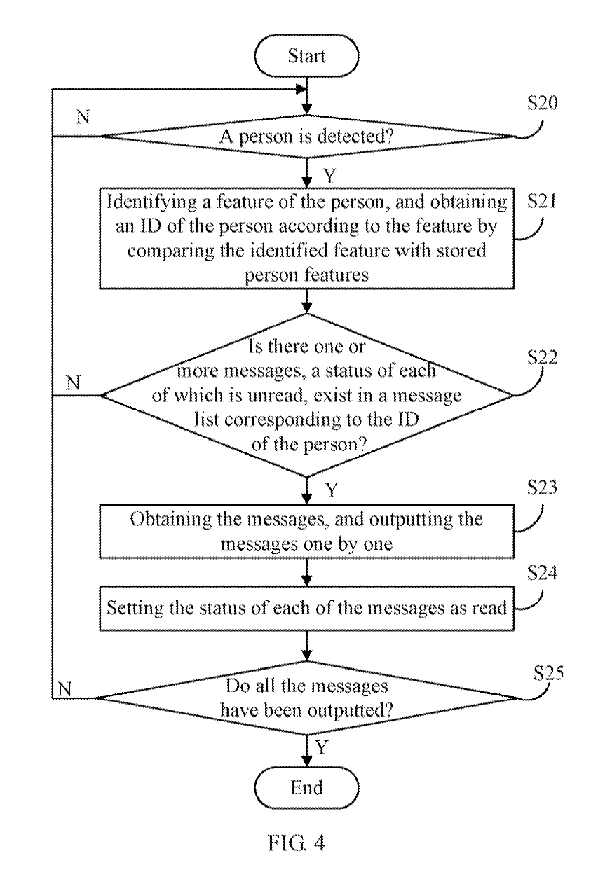

FIG. 4 illustrates a flowchart of one embodiment of a method of outputting messages. The method is executed by at least one processor of the electronic device 1. Depending on the embodiment, additional steps in FIG. 4 may be added, others removed, and the ordering of the steps may be changed.

In step S20, the detection module 101 determines if a person is detected using the detection device 13. When a person appears within a detection range of the detection device 13, the person can be detected by the detection device 13, and step S21 is implemented. Otherwise, step S20 is repeated until the detection device 13 has detected a person.

In step S21, the detection module 101 identifies a feature of the person using the detection device 13, and obtains an ID of the person by comparing the identified feature with person features pre-stored in the storage device 12 or the cloud server 3. The feature of the person may be a face of the person, a voice of the person, or fingerprints of the person.

In step S22, the message output module 102 determines if there is one or more messages, each with a status of unread, in a message list corresponding to the ID of the person. Step S23 is implemented if there is one or more messages, each with a status of unread, in a message list corresponding to the ID of the person. Otherwise, the process goes back to step S20.

In step S23, the message output module 103 obtains the one or more messages from the storage device 12 or the cloud server 3, and outputs the messages one by one using the output device 14.

In step S24, the message output module 103 sets the status of each of the messages, which has been outputted, as read.

In step S25, the message output module 103 determines if all the messages stored in the storage device 12 or the cloud server 3 has been outputted. When a status of each of the messages is read, the message output module 103 determines that all the messages have been outputted, then the procedure ends. Otherwise, when a status of any message is unread, the message output module 103 determines that not all the messages have been outputted, then, the process goes back to step S20.

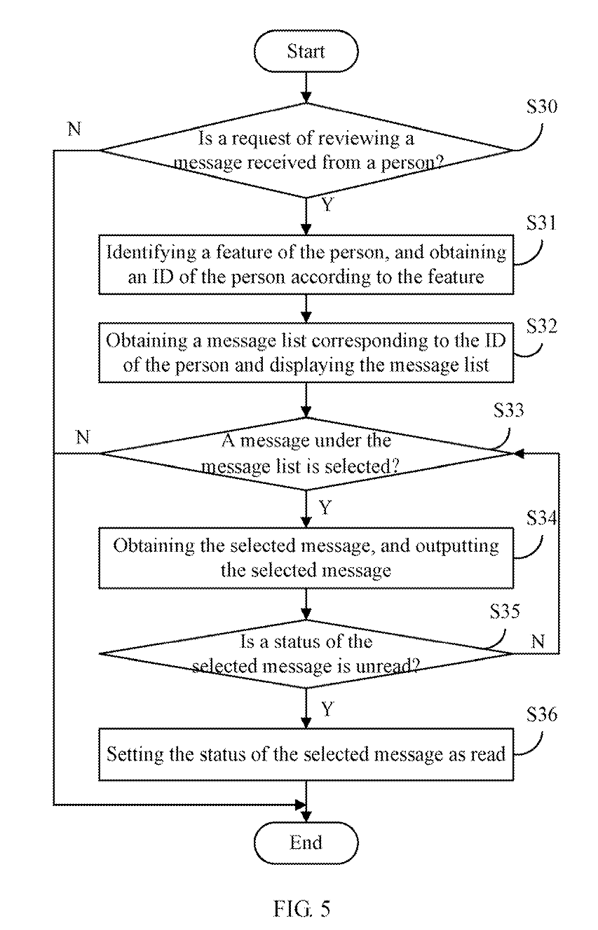

FIG. 5 illustrates a flowchart of another embodiment of a method of outputting messages. The method is executed by at least one processor of the electronic device 1. Depending on the embodiment, additional steps in FIG. 5 may be added, others removed, and the ordering of the steps may be changed.

In step S30, the detection module 102 determines if a request of reviewing a message is received. In one embodiment, a physical or virtual key is set to receive the request of reviewing a message. When the key is pressed or selected by a person, the detection module 102 determines that a request for reviewing a message is received, and step S31 is implemented. When the detection module 102 determines no request of reviewing a message is received, the procedure ends.

In step S31, the detection module 102 identifies a feature of the person using the detection device 13, and obtains an ID of the person by comparing the identified feature with person features pre-stored in the storage device 12 or the cloud server 3. As mentioned, the feature of the person may be a face of the person, a voice of the person, or fingerprints of the person.

In step S32, the message output module 103 obtains a message list corresponding to the ID of the person, and displays the message list on a display screen of the electronic device 1.

In step S33, the message output module 103 determines if a message under the message list is selected. When a message under the message list is selected, step S34 is implemented. Otherwise, when no message under the message list is selected, the procedure ends.

In step S34, the message output module 103 obtains the selected message from the storage device 12 or the cloud server 3, and outputs the selected message using the output device 14.

In step S35, the message output module 103 determines if a status of the selected message is unread. Step S36 is implemented when a status of the selected message is unread. Otherwise, the process goes back to step S33.

In step S36, the message output module 103 sets the status of the selected message as read.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A method of recording and outputting messages, the method being executed by a processor of an electronic device, the method comprising:
recording a message using an input device of the electronic device, and storing the message into a storage device of the electronic device;
identifying a person using a detection device of the electronic device; and
outputting the message corresponding to the identified person using an output device of the electronic device.

2. The method according to claim 1, wherein messages are characters, audio, and/or video.

3. The method according to claim 1, wherein the step of recording a message comprises:
selecting an identification (ID) of a message producer and an ID of a destined message receiver, from an ID list stored in the storage device;
inputting the message using the input device by the message producer, generating an ID for the message, and storing the message and the ID of the message into the storage device; and
inserting the ID of the message and the ID of the message producer into a message list corresponding to the ID of the destined message receiver, and setting a status of the message as unread.

4. The method according to claim 1, wherein the step of identifying a person comprises:
identifying a feature of a person which is detected by the detection device; and
obtaining an ID of the person by comparing the identified feature with person features pre-stored in the storage device.

5. The method according to claim 4, wherein the step of outputting the message corresponding to the identified person comprises:
determining if there is one or more messages, each with a status of unread, in a message list corresponding to the ID of the person;
obtaining the one or more messages from the storage device whose status are unread;
outputting the obtained messages one by one using the output device; and
setting the status of each of the messages, which has been outputted, as read.

6. The method according to claim 4, wherein the step of outputting the message corresponding to the identified person comprises:
determining if a request of reviewing a message is received from a person;
identifying a feature of the person using the detection device, and obtaining an ID of the person by comparing the identified feature with person features pre-stored in the storage device;
obtaining a message list corresponding to the ID of the person, and displaying the message list on a display screen of the electronic device;
obtaining a message selected from the message list from the storage device, and outputting the selected message using the output device; and
setting the status of the selected message as read.

7. An electronic device that executes a method of recording and outputting messages, the electronic device comprising:
an input device;
a detection device;
an output device;
one or more processors; and
one or more storage devices storing one or more programs which when executed by the processors, causes the electronic device to:
record a message using the input device, and store the message into a storage device of the electronic device;
identify a person using the detection device of the electronic device; and
output the message corresponding to the identified person using the output device of the electronic device

8. The electronic device according to claim 7, wherein messages are characters, audio, and/or video.

9. The electronic device according to claim 7, wherein when recording the message, causes the electronic device to:
select an identification (ID) of a message producer and an ID of a destined message receiver, from an ID list stored in the storage device;
input the message using the input device by the message producer, generate an ID for the message, and store the message and the ID of the message into the storage device; and
insert the ID of the message and the ID of the message producer into a message list corresponding to the ID of the destined message receiver, and set a status of the message as unread.

10. The electronic device according to claim 7, wherein when identifying the person, causers the electronic device to:
identify a feature of a person which is detected by the detection device; and
obtain an ID of the person by comparing the identified feature with person features pre-stored in the storage device.

11. The electronic device according to claim 10, wherein when outputting the message corresponding to the identified person, causes to the electronic device to:
determine if there is one or more messages, each with a status of unread, in a message list corresponding to the ID of the person;
obtain the one or more messages from the storage device whose status are unread;
output the obtained messages one by one using the output device; and
set the status of each of the messages, which has been outputted, as read.

12. The electronic device according to claim 10, wherein when outputting the message corresponding to the identified person, causes the electronic device to:
determine if a request of reviewing a message is received from a person;
identify a feature of the person using the detection device, and obtain an ID of the person by comparing the identified feature with person features pre-stored in the storage device;
obtain a message list corresponding to the ID of the person, and display the message list on a display screen of the electronic device;
obtain a message selected from the message list from the storage device, and output the selected message using the output device; and
set the status of the selected message as read.

13. The electronic device according to claim 7, wherein the input device comprises: a microphone, a sound recording pen, a touch screen, a keyword, or a video camera.

14. The electronic device according to claim 7, wherein the detection device comprises: a face detection device, a sound detection device, or a fingerprint detection device.

15. A non-transitory storage medium having stored thereon instructions that, when executed by one or more processors of an electronic device, causes the processors to perform a method of recording and outputting messages, wherein the method comprises:
recording a message using an input device of the electronic device, and storing the message into a storage device of the electronic device;
identifying a person using a detection device of the electronic device; and
outputting the message corresponding to the identified person using an output device of the electronic device.

16. The non-transitory storage medium according to claim 15, wherein messages are characters, audio, and/or video.

17. The non-transitory storage medium according to claim 15, wherein the step of recording a message comprises:
selecting an identification (ID) of a message producer and an ID of a destined message receiver, from an ID list stored in the storage device;
inputting the message using the input device by the message producer, generating an ID for the message, and storing the message and the ID of the message into the storage device; and
inserting the ID of the message and the ID of the message producer into a message list corresponding to the ID of the destined message receiver, and setting a status of the message as unread.

18. The non-transitory storage medium according to claim 15, wherein the step of identifying a person comprises:
identifying a feature of a person which is detected by the detection device; and
obtaining an ID of the person by comparing the identified feature with person features pre-stored in the storage device.

19. The non-transitory storage medium according to claim 18, wherein the step of outputting the message corresponding to the identified person comprises:
determining if there is one or more messages, each with a status of unread, in a message list corresponding to the ID of the person;
obtaining the one or more messages from the storage device whose status are unread;
outputting the obtained messages one by one using the output device; and
setting the status of each of the messages, which has been outputted, as read.

20. The non-transitory storage medium according to claim 18, wherein the step of outputting the message corresponding to the identified person comprises:
determining if a request of reviewing a message is received from a person;
identifying a feature of the person using the detection device, and obtaining an ID of the person by comparing the identified feature with person features pre-stored in the storage device;
obtaining a message list corresponding to the ID of the person, and displaying the message list of a display screen of the electronic device;
obtaining a message selected from the message list from the storage device, and outputting the selected message using the output device; and
setting the status of the selected message as read.
